(19) United States
(12) Patent Application Publication
(10) Pub. No.: US 2007/0209495 A1
(43) Pub. Date: Sep. 13, 2007

(54) Device For Cutting Feedthroughs Into A Block Of Insulating Material

(75) Inventor: Lionel Marcon, Montmorency (FR)

Correspondence Address: LEYDIG VOIT & MAYER, LTD, 700 THIRTEENTH ST. NW, SUITE 300, WASHINGTON, DC, 20005-3960, US

(73) Assignee: ETABLISSEMENTS PIERRE GREHAL ET CIE SA, SAINT-BRICE-SOUS-FORET (FR)

(21) Appl. No.: 10/577,935

(22) PCT Filed: Nov. 2, 2004
(86) PCT No.: PCT/FR04/02813

§ 371 Date: Jan. 19, 2007

(30) Foreign Application Priority Data
Nov. 3, 2003 (FR) 0312884

(51) Int. Cl. B26D 3/06

(52) U.S. Cl. 83/875

(57) ABSTRACT

The invention relates to a device which is used to cut feedthroughs into a free surface (11) of a block (1) of insulating material, such as expanded polystyrene or polyurethane. The inventive device (2) comprises: a base (20) which rests on the free surface (11) by means of a lower face (21), a handle (30) which is fixed to the base (20), and blades (40) which are solidly connected to the base (20) or handle (30) and which project out beneath the lower face (21).

The invention relates, in general, to the field of cutting tools.

More specifically, the invention relates to a device for cutting feedthroughs into a free surface of a block of insulating material, in particular expanded polystyrene or polyurethane.

These feedthroughs are grooves made in the free surface of the block, typically intended for feeding through sheaths inside of which electric wires run.

According to the prior art, these feedthroughs are created with the aid of carpet-type cutters.

This cutting-out work using a cutter is long and tedious. Moreover, the cutters are well suited for cutting out the sides of the feedthroughs, but not at all for cutting out the bottom thereof. Consequently, it is difficult to obtain a precise and uniform section along the entire feedthrough.

In this context, the objective of the present invention is to eliminate the above-mentioned defects.

To this end, the cutting device of the invention includes a base resting on the free surface of the block by way of a lower face, a handle fastened onto the base, and blades, integral with the base or handle, that project out beneath the lower face.

In one possible embodiment of the invention, the device includes two blades having respective planar lateral portions that are parallel to each other, these portions extending from the lower face along planes perpendicular to said face, said planes defining the perpendicular, longitudinal direction of movement of the device over the free surface.

Advantageously, said lateral portions of the blades have elongated shapes and extend obliquely from the lower face, on a longitudinal rear side of said face.

In addition, the blades each have a free end bent toward the other blade, extending the lateral portion on a side opposite the lower face, said free end running along a plane parallel to the lower face.

Preferably, the free end of one of the blades is offset from the free end of the other blade towards the rear.

In this case, the free ends of the blades have rear edges that are turned upward toward the lower face.

Furthermore, the handle has an elongated shape and extends out from the base substantially in line with the blades, on a longitudinal front side of the lower face opposite the longitudinal rear side.

In addition, the device includes means for selectively varying the angle formed between the handle and the lower face of the base.

For example, the device includes a T guide, equipped with a longitudinal profile having a right-angled cross section and a crossbar integral with the profile, the base comprising removable means of fastening to the rod with an adjustable transverse distance in relation to the profile.

In addition, the blades are removably fastened to the base.

Other characteristics and advantages of the invention will become apparent from the description thereof, provided below for purely non-limiting and illustrative purposes, with reference to the appended drawings of which:

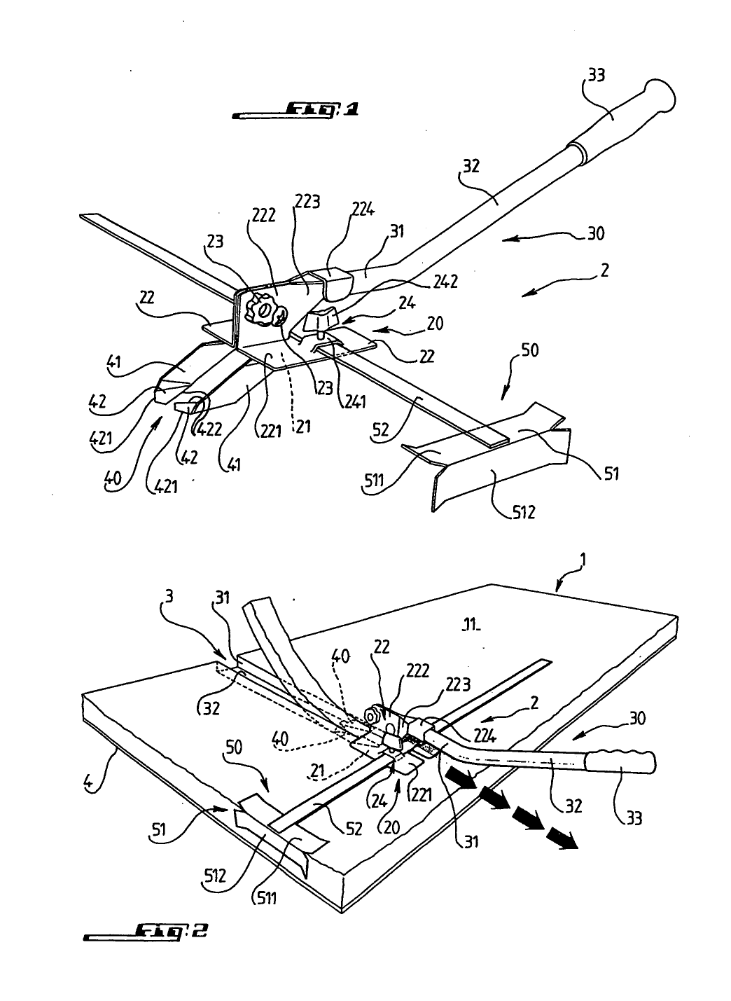

FIG. 1 is an oblique view of a cutting device according to the invention,

FIG. 2 is an oblique view of the device of FIG. 1 in the process of cutting out a block of insulating material,

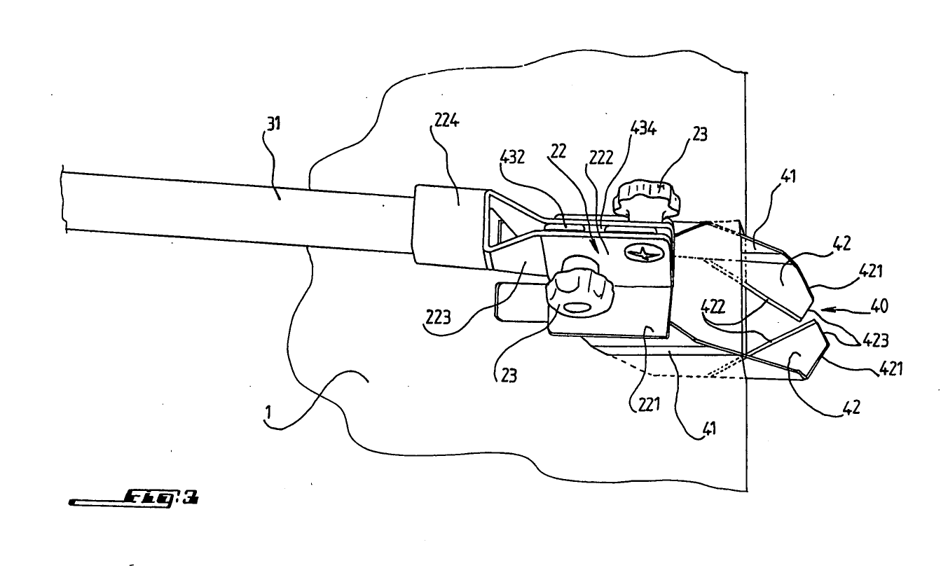

FIG. 3 is an oblique view of the device of FIG. 1 as it begins to cut out a block of insulating material,

FIG. 4 is an oblique view of the blades of the device of FIG. 1;

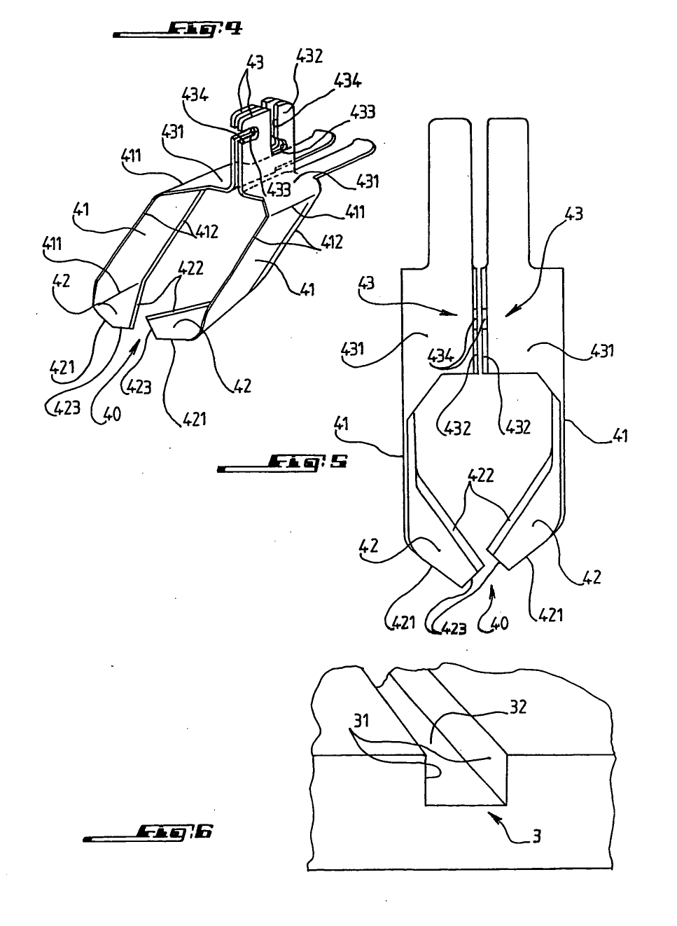

FIG. 5 is a top view of the blades of FIG. 4, and

FIG. 6 is an oblique view of a portion of a feedthrough that has been cut out with the device of FIG. 1.

The cutting device 2 shown in FIG. 2 is designed to create feedthroughs 3 in a free surface 11 of a block 1 of insulating material.

It is especially suited for cutting out light materials, foams, expanded materials, and in particular, expanded polystyrene or polyurethane, very frequently used for the thermal insulation of buildings.

As shown in FIG. 2, the cutting device 2 is suited, for example, for the creation of feedthroughs 3 in prefabricated rectangular panels, of considerable length and width and of slight thickness relative to the length or width.

Each of these panels consists of a plasterboard 4 and a sheet-like block 1 of insulating material that has been glued onto a large face of the plasterboard 4. The plasterboard and sheet of insulating material have the same length and width as the panel. The free surface 11 in which the cutting device 2 creates the feedthrough is the large face of the block 1 opposite from the plasterboard 4.

The device aims to create feedthroughs 3, which are grooves having a rectangular cross section in a plane perpendicular to the longitudinal direction in which said groove runs. These grooves are open at the free surface 11 and are delimited by two opposing lateral walls 31 and a bottom 32, as shown in FIG. 6.

The cutting device 2 includes a base 20 resting on the free surface 11 of the block 1 by way of a planar, lower face 21, a handle 30 fastened onto the base 20, and blades 40 that are integral with the base 20 or handle 30 and that project out beneath the lower face 21.

The blades 40 project into the thickness of the block 1.

More precisely, the device 2 includes two blades 40 having respective mutually parallel, planar lateral portions 41.

These portions 41 extend from the lower face 21 along planes that are perpendicular to said face, and that make it possible to cut out the lateral walls 31 of the feedthrough 3.

The planes along which the lateral portions 41 run define the perpendicular, longitudinal direction of movement of the cutting device 2 over the free surface 11.

The lateral portions 41 of the blades 40 each have an elongated shape and extend obliquely from the lower face 21 on a longitudinal rear side of said face 21.

More precisely, the lateral portions 41 are in the shape of parallelograms and are each delimited by two mutually parallel short longitudinal edges 411, and two mutually parallel long oblique edges 412. Viewed transversely, these oblique edges 412 form an angle of approximately 45° with the lower face 21.

The oblique edge 412 facing out from a longitudinal front side opposite from the rear side is sharp, and forms the cutting edge of the lateral portion 41 of the blade 40.

The cutting device 2 moves perpendicularly over the free surface 11 in the longitudinal direction, from back to front.

One of the short edges 411 runs in immediate proximity to the lower face 21.

The blades 40 also each have a free end 42 bent toward the other blade 40, extending the lateral portion 41 by way of the short edge opposite the lower face 21. This free end 412 runs along a plane parallel to the lower face 21.

The free ends 42 make it possible to cut out the bottom 32 of the feedthrough 3.

As shown in FIG. 5, the free ends 42 are each in the shape of a quadrilateral, delimited by the short edge 411 shared with the lateral portion 41, a leading edge 422 contiguous with the short edge 411 and facing forward, an outside edge 423 opposite the short edge 411 and running substantially perpendicular to the leading edge 422, and a rear edge 421 joining the short edge 411 to the edge 423.

The leading edge 422 runs rearward from the short edge 411. It is sharp and forms the cutting edge of the free end 42 of the blade 40. It runs over more than half the transverse distance between the lateral portions 41 of the two blades, said distance defining the transverse width of the feedthrough 3.

The rear edges 421 are turned up slightly toward the lower face 21.

As seen clearly in FIG. 5, the free end 42 of one of the blades 40 is offset towards the rear in relation to the free end 42 of the other blade. The leading edges 422 form a rearward pointing V, one of the arms of the V being offset towards the rear in relation to the other.

The blades 40 are suited for cutting out feedthroughs having a transverse width of 35 millimeters and a depth of 30 millimeters. The size of the lateral portions and the free ends can be altered to cut out feedthroughs having cross sections of different dimensions, either smaller or larger.

The base 20 includes two almost identical metal brackets 22, each having a horizontal plate 221 and a vertical plate 222 perpendicular to the horizontal plate. The vertical plates 222 of the two brackets 22 run parallel to one another, and parallel to the longitudinal direction. The horizontal plates 221 are the transverse extensions of one another and define the lower face 21.

The blades 40 each include an upper bent portion 43, integral with the lateral portion 42 by way of the short edge 411 closest to the base 20.

This upper portion 43 includes a connecting portion 431 integral with said short edge 411 and running substantially parallel to the lower face 21, and a fastening portion 432 running substantially perpendicular to the connecting portion 431 and becoming housed between the two vertical plates 222.

The connecting and fastening portions are thin plates, the fastening portion 432 running longitudinally, parallel to the two vertical plates 222.

The two vertical plates 222 and the fastening portions 432 of the blades 40 are each pierced by two openings. These openings are arranged so as to form extensions of one another in order to form two transverse perforations. The base 20 includes two bolts 23 inserted into these perforations and pressing the two vertical plates 222 and the two fastening portions 432 against one another so as to fasten them together firmly.

As seen in FIG. 4, it shall be noted that the openings 433 in the blades open out onto free edges of the fastening part 432 via cut-outs 434.

The blades 40 are thereby fastened onto the base 20 so as to be readily removable. To remove them, it suffices to loosen the bolts 23 slightly in order to separate the vertical plates 222, and to move the fastening portions 433 so as to slide the bolt out of the openings 433 and along the cut-outs 434 up to the free edges of the fastening portions 432.

The lower face 21 is typically in the shape of a square measuring 9 centimeters on each side.

The handle 30 has an elongated shape and extends from the base 20 on a longitudinal front side of the lower face 21. It runs in a generally oblique direction, substantially in line with the lateral portions 41 of the blades 40.

The handle 30 consists of a hollow metal tube and includes a first straight longitudinal segment 31 integral with the base 20 and substantially parallel with the lower face 21, and a second straight segment 32 that extends the first one on a side opposite the base 20, this second segment 32 running obliquely forward from the first one while moving away from the lower face 21. The free end of the second segment 32 forms a hand grip 33 capable of being manually grasped by a user of the device in order to move it in a longitudinal direction.

The brackets 22 each include an arm 223 extending longitudinally forward from the vertical plates 222, and constituting fastening flanges for the first segment 31 of the handle 30. A U-shaped piece 224 straddles the two flanges 223. Its two arms run parallel to the two flanges, on an exterior side thereof. The handle is welded onto the flanges and onto the U-shaped piece, said piece also being welded onto the flanges.

Finally, the cutting device 2 includes a guide T 50, equipped with a longitudinal profile 51 having an angle bracket cross section and a crossbar 52 integral with the profile, the base 20 including detachable means 24 of fastening onto the crossbar 52 with an adjustable transverse distance from the profile 51.

The profile 51 includes a horizontal wing 511 running along the same plane as the lower face 21, and a vertical wing 512 running perpendicular to the horizontal wing, in the longitudinal direction. The vertical wing 512 is integral with a longitudinal edge of the horizontal wing 511 opposite from the base 20. The vertical and horizontal wings have opposing front and rear edges that are turned slightly upward.

The profile 51, as shown in FIG. 2, is designed to follow an edge of the sheet of insulation 1, the horizontal wing 51 being positioned on the free surface 11, and the vertical wing 52 against the top edge of said sheet 1.

The crossbar 52 is welded onto a face of the horizontal wing 51 opposite from the sheet of insulation 1, and runs transversely over the respective faces of the horizontal plates 221 of the base 20 opposite from the sheet of insulation 1.

The removable fastening means 24 include a stirrup bracket 241 protruding from the surface of one of the horizontal plates 221 and into which the crossbar 52 is slid, and a locking screw 242 inserted into an opening of the stirrup bracket 241 and making it possible to press the crossbar against the horizontal plate in order to block its translational movement.

The guide T 50 thus makes it possible to guide the longitudinal movement of the cutting device 2, the profile 51 moving along the edge of the sheet 1 together with the base 20 and the blades 40.

It likewise makes it possible to adjust the distance between the edge of the sheet 1 and the feedthrough 3 being cut out.

The crossbar 52 typically has a transverse width of 60 centimeters, which makes it possible to adjust the position of the feedthrough 3, in relation to the edge of the sheet 1, within a range of distance running from a minimum of 7.5 centimeters to a maximum of 55 centimeters.

It shall be noted that the longitudinal length of the device is approximately 52 centimeters, including the handle.

The cutting device is very simple to use. In order to cut a feedthrough 3 into a sheet, the device is first positioned at a longitudinal edge of the sheet, the profile 51 being arranged on an edge of the sheet, and then the distance between the profile 51 and the base 20 is adjusted using the removable fastening means 24.

Then, the lateral portions 41 of the blades are driven into the thickness of the insulation, until the lower face 21 comes into contact with the free surface 11, the free ends 42 then being arranged on the exterior of the sheet 1, as shown in FIG. 3.

Next, the entire cutting device is pulled along longitudinally by the handle 30 in order to move said device across the entire sheet. The blades cut out the insulation in order to create the feedthrough, while the cut-out strip of insulation exits the feedthrough 3 naturally under the action of the turned-up rear edges 421 of the blades, as shown in FIG. 2.

In an alternative embodiment not shown, the cutting device 2 includes means for selectively varying the angle formed between the handle 30 and the lower face 21 of the base 20.

In this case, the handle 30 is not welded onto the base 20, but hinge-mounted onto it around a transverse pivot axis connection. It then holds a bolt plate, for example, which runs against one of the vertical plates 222 out of which is cut an arc-shaped slot centered on the transverse axis. Said vertical plate 222 holds a screw engaged in the slot, while a nut enables the bolt plate to be locked into the desired angular position.

Thus, it is well understood that the cutting device of the invention has multiple advantages.

It is very ergonomic, and enables a user to easily cutting out a feedthrough into a sheet of insulation without the user bending down or tiring.

The device is very simple to construct, and is therefore inexpensive.

The cut-out is made much more quickly than when using a cutter. It is also much cleaner, due to the bent shape of the blades.

The blades can be changed without having to detach the two brackets that form the base of the device. It suffices to slightly unscrew the bolts that press the two brackets together, in order to be able to remove the blades.

The guide T makes it possible both to accurately adjust the transverse position of the feedthrough being cut out, and to guide the movement of the device.

The turned-up rear edge of the blades pushes the cut-out strip of insulation out of the feedthrough. The user can grasp it without effort.

The oblique angle of the blades and handle enables the force exerted by the user to be properly transferred, without any risk of causing the device to tip over during the cutting operation.

Finally, it shall be noted that the device of the invention has been described with respect to its use for cutting out a sheet of insulation glued onto a plasterboard. It may likewise be used for cutting out feedthroughs in blocks of insulation having other shapes, provided that these blocks have a substantially planar free face enabling the base of the device to be moved along.

1. A device for cutting feedthroughs into a free surface of a block of a material, the device including:
a base having a lower face for resting on the free surface,
a handle fastened to the base, and
two blades integral with one of the base and the handle and projecting from the lower face, wherein
the blades having respective planar lateral portions that are mutually parallel, and
each blade has a free end bent toward the other blade.

2. The device according to claim 1, wherein the planar lateral portions extend from the lower face along planes perpendicular to the lower face, the planes defining a longitudinal direction of movement of the device over the free surface.

3. The device according to claim 2, wherein the free ends of the blades each extend the corresponding lateral portion of the blade on a side opposite the lower face, and the free end lies in a plane parallel to the lower face.

4. The device according to claim 2, wherein the free end of one of the blades is offset longitudinally from the free end of the other blade.

5. The device according to claim 2, wherein the free ends of the blades have rear edges turned toward the lower face.

6. The device according to 2, wherein the lateral portions of the blades have elongated shapes and extend obliquely from the lower face, on a rear longitudinal side of the lower face.

7. The device according to claim 6, wherein the handle has an elongated shape and extends from the base substantially aligned with the blades, on a front longitudinal side of the lower face, opposite the rear longitudinal side.

8. The device according to claim 7, including means for selectively varying an angle formed between the handle and the lower face of the base.

9. The device according to claim 1, including a guide T having a longitudinal profile with a right angled cross section and a crossbar integral with the profile, wherein the base includes means for detachable fixation and adjustment of the crossbar relative to the base.

10. The device according to claim 1, wherein the blades are detachably fastened to the base.
